(19) United States
(12) Patent Application Publication
(10) Pub. No.: US 2006/0068284 A1
(43) Pub. Date: Mar. 30, 2006

(54) Cell electrode and electrochemical cell

(76) Inventors: Naoki Takahashi, Miyagi (JP); Tomoki Nobuta, Miyagi (JP); Tetsuya Yoshinari, Miyagi (JP); Toshihiko Nishiyama, Miyagi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/231,164

(22) Filed: Sep. 20, 2005

(30) Foreign Application Priority Data
Sep. 28, 2004 (JP) 2004-282039

(51) Int. Cl. H01M 4/60; H01M 4/66

(52) U.S. Cl. 429/213; 429/234

(57) ABSTRACT

This invention relates to a cell electrode comprising a proton-conducting compound capable of being involved in a redox reaction in a solution of an electrolyte containing a proton source as an electrode-active material and a cation exchanger, and an electrochemical cell therewith.

### BACKGROUND OF THE INVENTION

1. Field of the Invention

This invention relates to an electrochemical cell such as a secondary battery and an electric double layer capacitor as well as an electrode suitable therefor.

2. Description of the Related Art

There have been suggested and practically used electrochemical cells such as secondary batteries and electric double layer capacitors in which a proton-conducting polymer is used as an electrode-active material.

FIG. 1 is a schematic cross-sectional view of such an electrochemical cell. On a cathodic current collector 1 and an anodic current collector 2 are formed a cathode 3 and an anode 4 comprising a proton-conducting compound as an electrode-active material, respectively, which are combined via a separator 5. The cell is filled with a solution containing a proton source as an electrolytic solution, and is sealed by a gasket 6. In this cell structure, only protons act as a charge carrier.

Japanese Patent Laid-Open No. 2000-195553 has disclosed technique for improving cycle-life properties of a non-aqueous electrolytic solution secondary battery. It has disclosed that cycle life at an elevated temperature properties can be improved in a secondary battery using a cathode comprising a complex oxide capable of insertion and release of lithium ions as an electrode-active material, an anode comprising a carbon powder capable of insertion and release of lithium ions as an electrode-active material and a non-aqueous electrolytic solution in which a lithium salt is dissolved.

In this technique, at least one of a cathode and an anode comprises at least one additive selected from the group consisting of chelating agents, polyimide resins, chelating resins, ion-exchangers and azoles and their derivatives. There is described that the ion-exchanger may be any of those capable of forming a chelate compound with a manganese ion and insoluble in a non-aqueous electrolytic solution, including cation- or zwitterion-exchanging organic and inorganic ion-exchangers. There is disclosed that such an ion-exchanger can be used to trap manganese ions eluted from the cathod-active material and thus to prevent precipitation of manganese to the anode, resulting in significant improvement of cycle-life properties.

Japanese Patent Laid-Open No. 1993-89905 has disclosed that an internal resistance can be reduced and a discharge capacity can be improved in a secondary battery comprising an electrolytic solution in which an iodine compound is dissolved. In the secondary battery, a porous conductor consisting of a polyamide with a porosity of 50 to 80% and particulate and/or a fibrous carbon body occupies a cathode chamber; continuous pores in the porous conductor are filled with an electrolytic solution; and the porous conductor is layered with a cation-exchange resin into an integrated part. The patent documents has described that in a battery where iodine is used as a cathod-active material, a cation-exchange membrane is inserted between a cathode and an anode for preventing self discharge due to iodine ions.

In an electrochemical cell comprising an aqueous solution containing a proton source as an electrolytic solution in which protons act as a charge carrier, there have been the problems of a large leak current and insufficient charge/discharge cycle properties.

In particular, when a redox material such as iron which may be involved in a redox reaction is contained as an impurity in an electrode, for example, electrons flow from a charged anode to a cathode via a redox reaction between bivalent and trivalent iron ions, that is, generation of a leak current. Since this phenomenon is caused by a trace amount of iron, it is difficult to sufficiently remove iron to prevent a leak current by a common method for purifying an electrode material. Attempt for complete removal of iron may lead to increase in a manufacturing cost for an electrode material.

A redox material which is contained in an electrode as an impurity influences charge/discharge properties of an electrochemical cell. For example, iron is oxidized in a cathode into ions, which is then moved to an anode by electrophoresis, subjected to chemical conversion into an insoluble salt such as iron hydroxide and precipitated. As a result, an internal resistance of the electrode may be increased, leading to deterioration in charge/discharge properties.

### SUMMARY OF THE INVENTION

An objective of this invention is to provide an electrode which can provide an electrochemical cell with a reduced leak current and improved charge/discharge cycle properties, as well as an electrochemical cell therewith.

According to an aspect of this invention, there is provided a cell electrode comprising a proton-conducting compound, as an electrode-active material, capable of being involved in a redox reaction in an electrolytic solution containing a proton source, and a cation exchanger.

According to another aspect of this invention, there is provided the cell electrode as described above, wherein the cation exchanger is dispersedly contained within the electrode.

According to another aspect of this invention, there is provided the cell electrode as described above, wherein the cation exchanger is contained in the surface layer of the electrode.

The cell electrode of this invention preferably contains the cation exchanger in 1 to 80 parts by weight to 100 parts by weight of the electrode-active material.

In the cell electrode of this invention, the cation exchanger is preferably fibrous. The cation exchanger is preferably an ion-exchange resin in which a substrate resin supporting a cation-exchange group consists of a thermoplastic resin. Furthermore, the substrate resin is preferably a polystyrene-polyolefin complex resin.

According to another aspect of this invention, there is provided an electrochemical cell comprising a cathode comprising a proton-conducting compound as an electrode-active material, an anode comprising a proton-conducting compound as an electrode-active material and an electrolyte containing a proton source, wherein at least one of the electrodes is any of the cell electrodes of this invention.

The electrochemical cell of this invention preferably comprises any of the cell electrodes of this invention as a cathode. The electrolyte is preferably an aqueous acid-containing solution.

This invention is suitable for an electrochemical cell in which protons act as a charge carrier in a redox reaction involved in charge/discharge.

The term, an “electrochemical cell” as used herein encompasses a secondary battery, an electric double layer capacitor, a redox capacitor and the like.

According to this invention, there can be provided an electrochemical cell with a reduced leak current and improved charge/discharge cycle properties, as well as an electrode suitable for such an electrochemical cell.

In this invention, the cation exchanger added to the electrode can trap an impurity involved in a redox reaction such as iron ions which may cause a leak current, so that electron transfer between the cathode and the anode associated with the redox reaction of the impurity, i. e., a leak current can be reduced.

The cation exchanger added to the electrode can trap an impurity involved in a redox reaction such as iron ions to prevent electrophoresis of the impurity such as iron ions to the anode and thus to prevent precipitation of an insoluble salt such as iron hydroxide within the anode, so that increase in an internal resistance can be prevented and an electrochemical cell having improved charge/discharge properties can be provided.

### BRIEF DESCRIPTION OF THE DRAWINGS

FIG. 1 is a schematic cross-sectional view of an electrochemical cell.

### DETAILED DESCRIPTION OF THE PREFERRED EMBODIMENTS

There will be described preferred embodiments of this invention.

A cell electrode for an electrochemical cell according to this invention comprises a proton-conducting compound as an electrode-active material and a cation-exchange resin, and, if necessary, a conductive auxiliary and a binder.

A content of the cation exchanger in the cell electrode is preferably 1 to 80 parts by weight, more preferably 1 to 50 parts by weight, further preferably 1 to 30 parts by weight to 100 parts by weight of the electrode-active material. A too small amount of the cation exchanger may not be sufficiently effective, while a too large amount may lead to deterioration of required electrode properties.

Examples of an ion-exchange group in the cation exchanger include strongly acidic groups such as sulfonic acid group and weakly acidic groups such as carboxyl group, and ions to be exchanged include, in addition to protons, alkali-metal ions such as lithium, sodium and potassium ions.

The cation exchanger is preferably a cation-exchange resin and a substrate resin therefor may be selected from acrylic resins, polystyrene resins, polyvinyl alcohol resins, Nylon resins, polyester resins, polystyrene-polyethylene complex resins and polystyrene-polypropylene complex resins. Such a resin can be complexed with a conductive auxiliary such as carbon powder to endow the resin with conductivity, and the resulting conductive resin can be used as a cation-exchange resin.

The substrate resin is preferably a thermoplastic resin; a preferable example is a polyolefin complex resin prepared by complexing a polyolefin such as polyethylene and polypropylene, e. g., a polystyrene-polyethylene complex resin and a polystyrene-polypropylene complex resin. Since the thermoplastic resin component in the cation exchanger can act as a binder, there can be provided a robust electrode cell in which electrode destruction due to swelling of the cation exchanger is prevented even when using an aqueous electrolytic solution.

A shape of the cation-exchange resin may be selected from various types such as a grain and a fiber, preferably a fiber.

A fibrous ion-exchange resin is preferable because it has a very large specific surface area and thus a very high ion-exchange rate. A fibrous cation-exchange resin is suitable because of its high-speed charge/discharge properties.

Using a fibrous ion-exchange fiber, an ion-exchange time until 80% of a theoretical ion-exchange capacity can be about one eighth of that in a granular ion-exchange resin with a particle size of 14 to 50 mesh and can be substantially equal to that in a granular ion-exchange resin with a particle size of 200 to 400 mesh.

A length of a fibrous cation-exchange resin is preferably up to 10 mm while a major axis is up to 100 μm. Since a fiber with a smaller diameter and a shorter length has a larger specific surface area, it is preferable to use a fiber whose diameter and length are within the above ranges. Such a fiber has an advantage that the ion-exchange fiber can be more homogeneously dispersed in an electrode material mixture and the ion-exchange resin can be homogeneously present near each reaction site of an electrode-active material in a balanced manner, resulting in improvement in an ion-exchange efficiency, reduced variation in an ion-exchange reaction and further improved battery properties. In the light of availability, facility in preparation and handling properties, a fiber length is preferably no less than 0.1 mm and a major axis is preferably no less than 1 μm.

There will be described a process for manufacturing a cathode using such a cation exchanger.

An electrode-active material (a proton-conducting compound: for example, an indole trimer compound), the above cation-exchange resin, a conductive auxiliary (for example, fibrous carbon) and a binder (for example, a polyvinylidene fluoride) are combined, and the mixed powder can be press-formed at, for example, 100 to 250° C. to give a cathode.

The conductive auxiliary can be added in, for example, 1 to 50 wt %, preferably 10 to 30 wt % to an electrode-active material, and the binder can be added in, for example, 1 to 20 wt %, preferably 5 to 10 wt % to an electrode-active material.

Although the ion-exchange resin is here combined with other electrode materials before molding, an electrode can be manufactured by forming an ion-exchange resin layer on an electrode surface. As an example of such a method, an electrode material comprising an electrode-active material, a conductive auxiliary and a binder is first molded, a cation-exchange resin is applied to the surface of the resulting molding in a mold, and then it is pressed. Alternatively, a dried electrode-material powder and a cation-exchange resin can be sequentially placed in a mold and then can be pressed together. Thus, there can be formed an electrode in which a cation exchanger is contained only in the surface layer of the electrode. The electrode is disposed such that the surface layer faces a separator. The surface layer of the electrode may be, as necessary, another electrode material in addition to the cation exchanger.

There will be described a process for manufacturing an anode.

An anode can be formed by combining a proton-conducting compound (e. g., polyphenylquinoxaline) as an anode-active material and, for example, a highly conductive carbon black as a conductive auxiliary, and then pressing and baking the mixture. An ion-exchange resin or binder may be, as necessary, added.

An electrochemical cell of this invention can comprise an electrode of this invention comprising a cation exchanger as at least one of a cathode and an anode, preferably as a cathode in the light of improving battery properties.

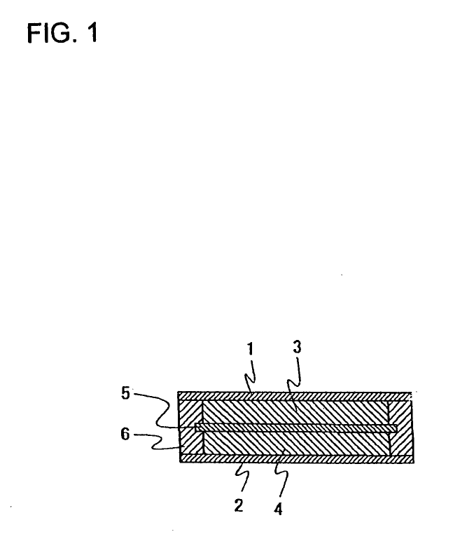

An electrochemical cell of this invention may have, as shown in FIG. 1, a configuration where a cathode 3 comprising a proton-conducting compound as an electrode-active material on a cathodic current collector 1 and an anode 4 comprising a proton-conducting compound as an electrode-active material on an anodic current collector 2 are mutually faced via a separator 5. A solution, preferably an aqueous solution, containing a proton-ionizing electrolyte as an electrolyte is enclosed by a gasket 6. The separator 5 may be, for example, a polyolefin porous membrane or cation-exchanger membrane with a thickness of 10 to 50 μm.

An electrochemical cell may have a conventional external appearance such as, but not limited to, a coin and a laminate.

A proton source in the proton-source-containing (proton donating) electrolyte may be an inorganic or organic acid. Examples of an inorganic acid include sulfuric acid, nitric acid, hydrochloric acid, phosphoric acid, tetrafluoroboric acid, hexafluorophosphoric acid and hexafluorosilicic acid. Examples of an organic acid include saturated monocarboxylic acids, aliphatic carboxylic acids, oxycarboxylic acids, p-toluenesulfonic acid, polyvinylsulfonic acid and lauric acid. Among these proton-source-containing electrolytes, an aqueous acid-containing solution is preferable and an aqueous solution of sulfuric acid is particularly preferable.

A proton concentration in an electrolytic solution containing a proton source is preferably 10⁻³ mol/L or more, more preferably 10⁻¹ mol/L or more in the light of reactivity of the electrode materials while being preferably 18 mol/L or less, more preferably 7 mol/L or less in the light of deterioration in activity of the electrode materials and prevention of dissolution.

A preferable electrochemical cell of this invention may be an electrochemical cell which is operable such that as a charge carrier, protons are exclusively involved in a redox reaction associated with charge/discharge in both electrodes; more specifically, an electrochemical cell comprising an electrolytic solution containing a proton source, where a proton concentration in the electrolyte and an operating voltage are controlled to allow the cell to operate such that adsorption/desorption of a proton in the electrode-active material may be exclusively involved in electron transfer in a redox reaction in both electrodes associated with charge/discharge.

Reaction equation (1) shows a reaction of an indole trimer compound as one of proton-conducting compounds. The first step shows a doping reaction and the second step shows an electrochemical reaction (electrode reaction) involving adsorption/desorption of a proton in a doped compound. In this equation, X⁻ is a dopant ion such as a sulfate or halide ion, which dopes a proton-conducting compound to endow it with electrochemical activity.

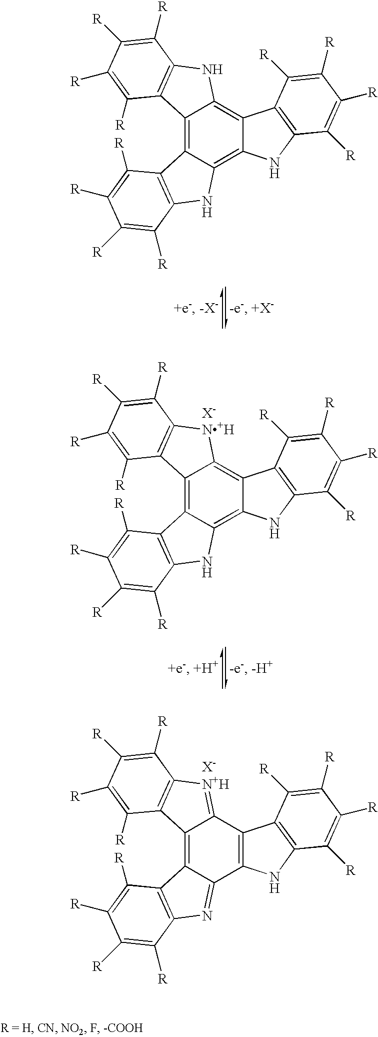

In an electrochemical cell in which such an electrode reaction occurs, proton adsorption/desorption is exclusively involved in electron transfer in a redox reaction, so that only protons are transferred during charge/discharge. Consequently, it results in reduced volume variation in the electrode associated with a reaction and better cycle properties. Furthermore, a higher proton-transfer rate can accelerate a reaction, resulting in improved high-rate properties, i. e., improved high-speed charge/discharge properties.

As described above, an electrode-active material in this invention is a proton-conducting compound, which is an organic compound (including a polymer) capable of storing electrochemical energy by a reaction with ions of an electrolyte.

Such a proton-conducting compound may be any of known compound conventionally used; for example, π-conjugated polymers such as polyaniline, polythiophene, polypyrrole, polyacetylene, poly-p-phenylene, polyphenylene-vinylene, polyperinaphthalene, polyfuran, polyflurane, polythienylene, polypyridinediyl, polyisothianaphthene, polyquinoxaline, polypyridine, polypyrimidine, polyindole, polyaminoanthraquinone, polyimidazole and their derivatives; indole π-conjugated compound such as an indole trimer compound; quinones such as benzoquinone, naphthoquinone and anthraquinone; quinone polymers such as polyanthraquinone, polynaphthoquinone and polybenzoquinone where a quinone oxygen can be converted into a hydroxyl group by conjugation; and proton-conducting polymer prepared by copolymerizing two or more of the monomers giving the above polymers. These compounds may be doped to form a redox pair for exhibiting conductivity. These compounds are appropriately selected as a cathode and an anode activators, taking a redox potential difference into account.

Preferable examples of a proton-conducting compound include π-conjugated compounds or polymers, quinone compounds and quinone polymers.

Among these, a preferable cathode-active material is an indole trimer compound and a preferable anode activator is a quinoxaline polymer.

An indole trimer compound has a fused cyclic structure comprising a six-membered ring formed by atoms at 2- and 3-positions in three indole rings. The indole trimer compound can be prepared from one or more compounds selected from indole or indole derivatives or alternatively indoline or its derivatives, by a known electrochemical or chemical process.

Examples of such indole trimer compound include those represented by the following chemical formula: 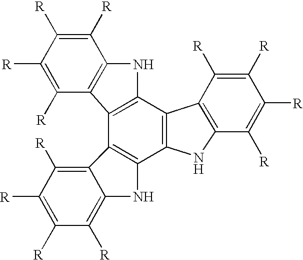
wherein Rs independently represent hydrogen atom, hydroxyl group, carboxyl group, nitro group, phenyl group, vinyl group, halogen atoms, acyl groups, cyano group, amino group, trifluoromethyl group, sulfonic acid group, trifluoromethylthio group, carboxylate groups, sulfonate groups, alkoxyl groups, alkylthio groups, arylthio groups, alkyl groups having 1 to 20 carbon atoms optionally substituted with these substituents, aryl groups having 6 to 20 carbon atoms optionally substituted with these substituents or heterocyclic residues.

In the formula, examples of halogen atom in R include fluorine, chlorine, bromine and iodine atoms. Examples of alkyl groups in R in the formula include methyl, ethyl, propyl, isopropyl, n-butyl, s-butyl, isobutyl, t-butyl, n-pentyl, n-hexyl, n-heptyl and n-octyl groups. Acyl group in R in the formula is a substituent represented by —COX, wherein X may be alkyl as described above. Alkoxyl group in R in the formula is a substituent represented by —OX, wherein X may be alkyl as described above. Examples of aryl group in R in the formula include phenyl, naphthyl and anthryl groups. The alkyl moiety in alkylthio group in R in the formula may be selected from those described above. The aryl moiety in arylthio group in R in the formula may be selected from those described above. Examples of heterocyclic residue in R in the formula include 3- to 10-membered cyclic radicals having 2 to 20 carbon atoms and 1 to 5 heteroatoms which may be selected from oxygen, sulfur and nitrogen.

A quinoxaline polymer is a polymer having a unit containing a quinoxaline moiety, and may be a polymer having a quinoxaline structure represented by the following chemical formula: 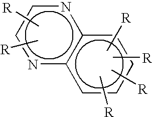
wherein Rs may be contained as a linker in a main chain or as a side chain group; Rs independently represent hydrogen atom, hydroxyl group, amino group, carboxyl group, nitro group, phenyl group, vinyl group, halogen groups, acyl groups, cyano group, trifluoromethyl group, sulfonyl group, sulfonic acid group, trifluoromethylthio group, alkoxyl groups, alkylthio groups, arylthio groups, carboxylate groups, sulfonate groups, alkyl groups having 1 to 20 carbon atoms optionally substituted with these substituents, aryl groups having 6 to 20 carbon atoms optionally substituted with these substituents or heterocyclic residues.

In the formula, examples of halogen atom in R include fluorine, chlorine, bromine and iodine atoms. Examples of alkyl group in R in the formula include methyl, ethyl, propyl, isopropyl, n-butyl, s-butyl, isobutyl, t-butyl, n-pentyl, n-hexyl, n-heptyl and n-octyl groups. Acyl group in R in the formula is a substituent represented by —COX, wherein X may be alkyl as described above. Alkoxyl group in R in the formula is a substituent represented by —OX, wherein X may be alkyl as described above. Examples of aryl group in R in the formula include phenyl, naphthyl and anthryl groups. The alkyl moiety in alkylthio group in R in the formula may be selected from those described above. The aryl moiety in arylthio group in R in the formula may be selected from those described above. Examples of heterocyclic residue in R in the formula include 3- to 1 0-membered cyclic radicals having 2 to 20 carbon atoms and 1 to 5 heteroatoms which may be selected from oxygen, sulfur and nitrogen.

A preferable quinoxaline polymer is a polymer containing 2,2′-(p-phenylene)diquinoxaline moiety and may be a polyphenylquinoxaline represented by the following formula: 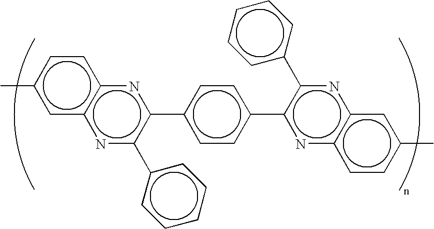
wherein n represents a positive integer.

### EXAMPLES

This invention will be more specifically described with reference to examples.

### Example 1

5-Cyanoindole trimer which is a proton-conducting compound as a cathode-active material, fibrous carbon as a conductive auxiliary (Showa Denko K.K., vapor-phase growth carbon fiber: VGCF®) and polyvinylidene fluoride as a binder were sequentially weighed at a weight ratio of 69/23/8. The mixture was mixed by stirring with a blender. A cation-exchanger was a cation-exchange fiber produced by bicomponent fiber spinning of a polystyrene resin having a sulfonic acid group as an ion-exchange group and polyethylene (trade name: ION EX, TIN-110H03E, exchanged-ion type: H type, fiber length: 0.3 mm, Toray Industries, Inc.). To the mixture was added the cation exchanger in 10 wt % to the cathode-active material, and the mixture was fully mixed by stirring. The mixed powder was pressed at 200° C. to form a cathode.

Polyphenylquinoxaline which is a proton-conducting compound as an anode-active material and Ketjen Black (Ketjen Black International Inc., EC600JD) as a conductive auxiliary were sequentially weighed at a weight ratio of 72/28, and were mixed by stirring with a blender. The mixture was pressed at 300° C. and baked at 500° C. to form an anode.

An electrolytic solution was an aqueous 20 wt % solution of sulfuric acid. A separator was a cation-exchange membrane with a thickness of 15 μm.

The cathode and the anode are combined via the separator, facing to each other. Then, current collectors and a gasket were disposed to form an electrochemical cell as shown in FIG. 1.

The electrochemical cell thus produced was evaluated as follows. It was charged at a constant current (5 C) and a constant voltage for 10 min, and then discharged at a constant current (1 C) to a discharge depth of 100%. An end current in constant-voltage charging was determined as a leak current, which was evaluated as a relative value to that obtained in Comparative Example 1 described below. Furthermore, charge/discharge cycle properties were evaluated with a residual capacity rate after 5000 cycles of charge/discharge, where a charge voltage per a base element was 1.2 V and an evaluation temperature was 25° C.

Table 1 shows the evaluation results. It can be seen that a leak current in this example was reduced to 70% to that in Comparative Example 1 and that charge/discharge cycle properties was improved by 22%.

### Example 2

An electrochemical cell was prepared as described in Example 1, except that an amount of the cation exchanger was added in 70 wt % to the cathode-active material.

Table 1 shows the evaluation results. It can be seen that a leak current in this example was reduced to 74% to that in Comparative Example 1 and that charge/discharge cycle properties was improved by 9%.

### Example 3

An electrochemical cell was prepared as described in Example 1, except that a cathode was prepared as follows.

5-Cyanoindole trimer which is a proton-conducting compound as a cathode-active material, fibrous carbon as a conductive auxiliary (Showa Denko K.K., vapor-phase growth carbon fiber: VGCF®) and polyvinylidene fluoride as a binder were sequentially weighed at a weight ratio of 69/23/8. The mixture was mixed by stirring with a blender. The mixed powder was pressed at 200° C. On the surface of the molding was placed the cation exchanger in Example 1 in 10 wt % to the cathode-active material, and the molding was pressed at 200° C. to prepare a cathode having a surface layer consisting of the cation exchanger.

Table 1 shows the evaluation results. It can be seen that a leak current in this example was reduced to 68% to that in Comparative Example 1 and that charge/discharge cycle properties was improved by 11%.

### Example 4

An electrochemical cell was prepared as described in Example 1, except that a granular polystyrene cation-exchange resin (Organo Corporation, trade name: Amberlite 200CT-Na, ion-exchange group: sulfonic acid group, ion-exchange type: Na type) was used as a cation exchanger.

Table 1 shows the evaluation results. It can be seen that a leak current in this example was reduced to 87% to that in Comparative Example 1 and that charge/discharge cycle properties was improved by 4%.

### Comparative Example 1

An electrochemical cell was prepared as described in Example 1, except that a cation exchanger was not added in preparation of a cathode.

TABLE 1

| | Leak current | Charge/discharge properties |
|---|---|---|
| | (Relative value to | (Residual capacity rate (%) |
| | Comparative Example 1) | after 5000 cycles) |
| Example 1 | 70 | 92 |
| Example 2 | 74 | 79 |
| Example 3 | 68 | 81 |
| Example 4 | 87 | 74 |
| Comparative | 100 | 70 |
| Example 1 | | |

As seen from Table 1, this invention can reduce a leak current and improve charge/discharge properties in comparison with the prior art.

A first effect of this invention is that a cation exchanger contained in a cathode traps iron ions generated by oxidation of iron contained in an electrode-active material as an impurity and thus inhibits electrophoresis of the iron ions to an anode to prevent electron transfer between the cathode and the anode. That is, a leak current associated with a redox reaction of iron can be prevented.

A second effect of this invention is that since a cation exchanger contained in a cathode contributes to fixation of iron on the cathode, electrophoresis of iron ions to an anode can be inhibited to prevent iron from being precipitated in the anode. As a result, increase of an internal resistance in the anode can be prevented and charge/discharge cycle properties can be improved.

The effects of this invention can be applied, besides an electrode containing iron as an impurity, an electrode containing a transition metal such as copper, zinc, lead and nickel or a halide thereof such as a chloride and a bromide.

1. A cell electrode comprising a proton-conducting compound, as an electrode-active material, capable of being involved in a redox reaction in an electrolytic solution containing a proton source, and a cation exchanger.

2. The cell electrode as claimed in claim 1, wherein the cation exchanger is contained in 1 to 80 parts by weight to 100 parts by weight of the electrode-active material.

3. The cell electrode as claimed in claim 1, wherein the cation exchanger is dispersedly contained within the electrode.

4. The cell electrode as claimed in claim 1, wherein the cation exchanger is contained in the surface layer of the electrode.

5. The cell electrode as claimed in claim 1, wherein the cation exchanger is fibrous.

6. The cell electrode as claimed in claim 1, wherein the cation exchanger is an ion-exchange resin in which a substrate resin supporting a cation-exchange group consists of a thermoplastic resin.

7. The cell electrode as claimed in claim 6, wherein the substrate resin is a polystyrene-polyolefin complex resin.

8. An electrochemical cell comprising a cathode comprising a proton-conducting compound as an electrode-active material, an anode comprising a proton-conducting compound as an electrode-active material and an electrolyte containing a proton source, wherein at least one of the electrodes is the electrode as claimed in claim 1.

9. The electrochemical cell as claimed in claim 8, wherein the cathode is a cell electrode comprising a proton-conducting compound, as an electrode-active material, capable of being involved in a redox reaction in an electrolytic solution containing a proton source, and a cation exchanger.

10. The electrochemical cell as claimed in claim 8, wherein the electrolyte is an aqueous acid-containing solution.

11. A cell electrode comprising:
an electrode-active material constituted by a proton-conducting compound for performing a redox reaction in an electrolytic solution containing a proton source; and
a cation exchanger dispersed at least in a surface layer of the cell electrode in an amount effective to trap an impurity such as iron ions involved in the redox reaction.

12. The cell electrode as claimed in claim 11, wherein the cation exchanger is contained in 1 to 80 parts by weight relative to 100 parts by weight of the electrode-active material.

13. The cell electrode as claimed in claim 11, wherein the cation exchanger has an ion-exchange group selected from the group consisting of strongly acidic groups including sulfonic acid group and weakly acidic groups including carboxyl group, and the cation exchanger is capable of exchanging ions selected from the group consisting of alkali-metal ions including lithium, sodium, and potassium ions, in addition to protons.

14. The cell electrode as claimed in claim 11, wherein the cation exchanger is a cation-exchange resin composed of a substrate resin selected from the group consisting of acrylic resins, polystyrene resins, polyvinyl alcohol resins, Nylon resins, polyester resins, polystyrene-polyethylene complex resins, and polystyrene-polypropylene complex resins.

15. The cell electrode as claimed in claim 14, wherein the cation-exchange resin is a fibrous cation-exchange resin having a length of 10 mm or less and having a major axis of 100 μm or less.

16. The cell electrode as claimed in claim 11, further comprising a conductive auxiliary in an amount of 1 to 50 wt % relative to the electrode-active material, and a binder in an amount of 1 to 20 wt % relative to the electrode-active material.

17. The cell electrode as claimed in claim 11, which is press-formed.

18. An electrochemical cell comprising:
a cathode comprising a proton-conducting compound as an electrode-active material;
an anode comprising a proton-conducting compound as an electrode-active material; and
an electrolyte containing a proton source,
wherein at least one of the cathode or anode electrode is the electrode of claim 11.

19. The electrochemical cell as claimed in claim 18, further comprising a separator disposed between the cathode and the anode.

20. The electrochemical cell as claimed in claim 18, wherein the electrolyte is an aqueous acid-containing solution.
